(19) United States
(12) Patent Application Publication
(10) Pub. No.: US 2017/0310614 A1
(43) Pub. Date: Oct. 26, 2017

(54) A new Instant Messaging (IM) system

(71) Applicant: Beijing VRV Software Corporation Limited, Beijing (CN)

(72) Inventors: Hao LIN, Beijing (CN); Xi GAO, Beijing (CN); Li ZHONG, Beijing (CN); Hua YANG, Beijing (CN)

(21) Appl. No.: 15/507,991

(22) PCT Filed: Jul. 7, 2015
(86) PCT No.: PCT/MY2015/050067

§ 371 Date: Mar. 1, 2017

(30) Foreign Application Priority Data
May 15, 2015 (CN) 201510247834.7

(51) Int. Cl. H04L 12/58; H04L 29/06

(52) U.S. Cl. CPC H04L 51/04; H04L 67/42

(57) ABSTRACT

A new Instant Messaging (IM) system is provided which includes “Client”, “Server” and “Router” and which utilizes an innovative three layered system structure of “Routing+Service+User”. A user utilizes “Client” as the interface for Instant Messaging (IM); “Server” provides Instant Messaging (IM) service and various enterprise applications to “Client”; “Router” are mainly used for managing connection of “Server”, and providing the addressing service for the network connection amongst the “Server”. A technical effect of this invention is: a new Instant Messaging (IM) system is implemented via routing and control from the upper layer, any private, dedicated and public Instant Messaging (IM) servers of various enterprises or organizations can securely and seamlessly connect each other. Thus all public, enterprises or organizations' users can communicate in a fast and flexible manner. At the same time, the privacy and confidentiality of the Instant Messaging (IM) content will be assured.

### CROSS-REFERENCE TO RELATED APPLICATIONS

This application is a Section 371 National Stage application of International Application PCT/MY2015/050067, filed on 7 Jul. 2015, which published as WO 2016/186484 A1 on 24 Nov. 2016, entitled “A new Instant Messaging (IM) system”, which claims priority to Chinese Patent Application 201510247834.7, filed on 15 May 2015, the contents of which are hereby incorporated in their entirety.

### TECHNICAL FIELD

This invention is classified as messaging technology, relating to the technique of creating private or public Instant Messaging (IM) systems that can interconnect and communicate under the circumstances of internet, enterprise intranet and cloud computing, especially to providing a cross-network Instant Messaging (IM) system for individual, institutions, enterprises or organizations.

### BACKGROUND ART

Instant Messaging (IM) is a service on mobile phones, tablet PCs and computer to send and receive text, picture, audio clips, video clips via a network; it is one of the common applications on internet.

The popular Instant Messaging (IM) services includes: WeChat, QQ, Skype, RTX (Real Time eXpert), e-contact and others. The first three players aimed at public users; while the remaining two players aimed at users from enterprises or organizations.

In light of the rapid development of the internet and customer needs, collaborations from enterprises or organizations have increased tremendously, and many of them are international collaborations. As the result of its high efficiency and flexibility, Instant Messaging (IM) has been accepted and its usage surged amongst enterprises and organizations. In the enterprise Instant Messaging (IM) environment, the following needs arise:

(1), To ensure the privacy and confidentiality of enterprise Instant Messaging (IM), enterprise needs to have its own private Instant Messaging (IM) server;
(2), To be able to connect Instant Messaging (IM) with other enterprises, different Instant Messaging (IM) system needs to be interconnected and communicated.

Currently, most Instant Messaging (IM) systems use “Client layer+Server layer” which is a two layer structure, that representing the Instant Messaging (IM) server and Instant Messaging (IM) client software. There are two types of commercial Instant Messaging (IM) services on the market:

Large scale Instant Messaging (IM) network aimed at public users, for example: WeChat and QQ.

Small scale Instant Messaging (IM) network aimed at internal users of enterprise or organizations, for example: RTX (Real Time eXpert); but Instant Messaging (IM) system of various enterprises or organizations are unable to be interconnected, not to mention the challenge of connecting the Instant Messaging (IM) network that aimed at public users.

E-contact is an Instant Messaging (IM) service platform that aimed at small organization or enterprise, features one main controller and a backup controller, allowing different enterprise or organizations' users to connect Instant Messaging (IM) on this common platform, but enterprises or organizations can't have their own private server.

Another possible solution is to provide protocol converter gateway for different Instant Messaging (IM) system, but this can only solve the connectivity between two Instant Messaging (IM) systems, it is unable to resolve issue on multiple systems.

Clearly, the current commercial Instant Messaging (IM) systems available on the market still not able to satisfy and fulfill the two type of needs for users mentioned above on enterprise application of Instant Messaging (IM), nor to solve the interconnecting and privacy issue.

### DISCLOSURE OF INVENTION

The object of this invention is to provide an Instant Messaging (IM) system that is able to operate amongst the internet, enterprise intranet, cloud computing platform and various complex network environments, and fulfill the user needs o Instant Messaging (IM) security, interconnectivity and communication. Using the proposed system, user can deploy private Instant Messaging (IM) server locally within their own intranet, or they can lease the cloud service to deploy dedicated Instant Messaging (IM) server, even or utilize the public Instant Messaging (IM) server that aimed at public users. Moreover, these various types of servers will be able to interconnect to provide unified Instant Messaging (IM) services.

This invention discloses a new Instant Messaging (IM) system, utilizing “Routing+Service+User”, which is an innovative three layered system structure, in order to build a flexible, scalable Instant Messaging (IM) system. The system is formed by “Client”, “Server” and “Router”, the details are as follows:

### (1) “Client”

“Client” is in the form of software, which is distributed by the “Server”, and installed at the user's mobile phone, tablet, or computer, act as the user interface of Instant Messaging (IM) system. “Client” use Instant Messaging (IM) to connect to each other through the “Server”; receive broadcast message, use biometric attendance, create temporary task group, group administration, task assignment, email and other enterprise application.

### (2) “Server”

“Server” is in the form of software, which is installed onto the server, to provide biometric attendance, create temporary task group, group administration, task assignment, email, enterprise applications, message broadcast, and Instant Messaging (IM) service; the “Server” are directly connected based on the network address, doesn't require network address routing from the “Router” when the network address of target “Server” is known, once connection is established, information of user and communication information required to facilitate Instant Messaging (IM) will be shared.

The “Server” can be a private Instant Messaging (IM) server by enterprises or organizations, or dedicated Instant Messaging (IM) server leased by users from various enterprises or organizations, or public Instant Messaging (IM) server deployed by service providers. After acquiring authorization from the owner of the server, these servers can interconnect and communicate to form a scalable Instant Messaging (IM) service network.

### (3) “Router”

“Router” can be installed at the server or to be made as a hardware device, for managing the connection of “Server”, and providing addressing service for the network connection amongst the “Server”;

Every “Router” will provide addressing service to facilitate the communication and connection among the “Server”, every “Router” will provide addressing service to one or more “Server”, and every “Server” will only accept addressing service from a specific “Router”.

“Router” are uniformly deployed by the equipment vendor, for creating core backbone Instant Messaging (IM) routing service network; multiple enterprises or organizations, and Instant Messaging (IM) service provider can build larger scale of Instant Messaging (IM) network through deployment of “Router”, and able to link to the core backbone Instant Messaging (IM) service network.

When source “Server” requires the network address of the target “Server”, the source “Server” will request address from the “Router”, the “Router” will seek address in the router service network based on the identification information of Target “Server” and routing strategy, and respond to the source “Server” when the target “Server” address is found.

### DESCRIPTION OF DRAWINGS AND BEST MODE FOR CARRYING OUT THE INVENTION

The following will further elaborate the new Instant Messaging (IM) system and its deployment method:

FIG. 1: Structure diagram of the invention—A new Instant Messaging (IM) system

FIG. 2: System deployment diagram of the invention—A new Instant Messaging (IM) system

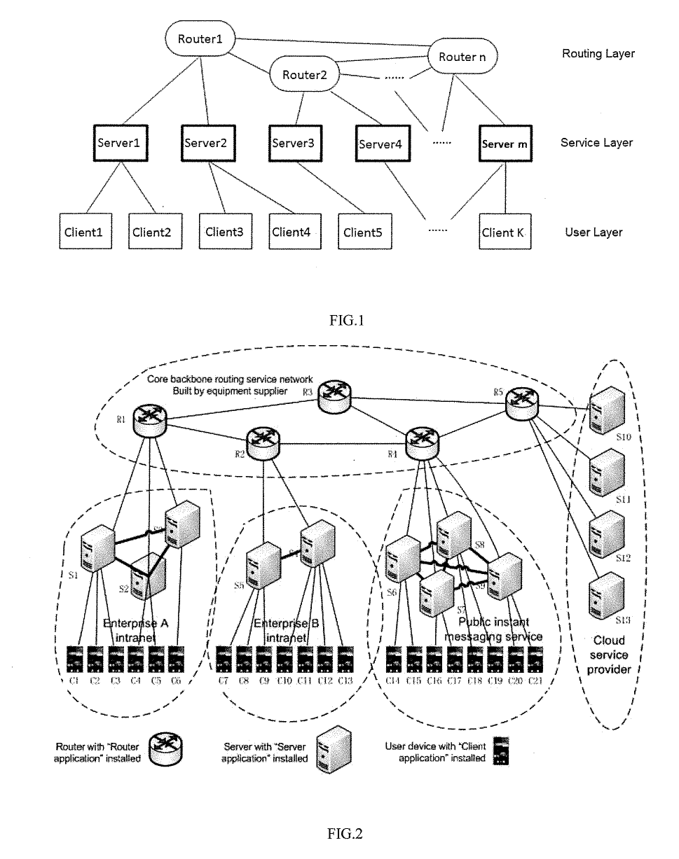

FIG. 1 is the Structure diagram of the Instant Messaging (IM) system.

The system utilizing “Routing+Service+User”, which is an innovative three layered system structure comprising of “Client”, “Server” and “Router”, in order to build a flexible, scalable Instant Messaging (IM) system.

The specific embodiments are as follows:

### (1) “Client”

“Client” is in the form of software, to be distributed by the “Server”, and installed at the user's mobile phone, tablet, or computer, act as the interface of Instant Messaging (IM) system, “Client” conduct Instant Messaging (IM) with each other through the “Server”; receive broadcast message, use biometric attendance, create temporary task group, group administration, task assignment, email and other enterprise applications.

“Client” supports multiple user accounts, user can utilize “Client” in a terminal to access multiple “Server” to create account, thus can connect various Instant Messaging (IM) conversations using various account identities.

### (2) “Server”

“Server” is in the form of software, to be installed at the server, to provide biometric attendance, create temporary task group, group administration, task assignment, email, enterprise application, Instant Messaging (IM) service, and message broadcast; the “Server” are directly connected based on the network address, doesn't need network address routing from the “Router” when the network address of target “Server” is known, once connection is established, information of user and communication information required to facilitate Instant Messaging (IM) will be shared.

The “Server” can be a private Instant Messaging (IM) server of enterprise or organization, or dedicated Instant Messaging (IM) server leased by users from various enterprise or organizations, or public Instant Messaging (IM) server deployed by service providers. After acquiring authorization from the owner of the server, these servers can interconnect and communicate to form a scalable Instant Messaging (IM) service network.

### (3) “Router”

“Router” can be installed at the server or to be made as a hardware device, for managing the connection of “Server”, and providing the addressing service for the network connection amongst the “Server”.

Every “Router” will provide addressing service to facilitate the communication and connection amongst the “Server”, every “Router” will provide addressing service to one or more “Server”, and every “Server” will only accept addressing service from a specific “Router”.

“Router” are uniformly deployed by the equipment vendor, for creating core backbone Instant Messaging (IM) routing service network; multiple enterprises or organizations, and Instant Messaging (IM) service provider can build larger scale of Instant Messaging (IM) network through deployment of “Router”, and able to link to the core backbone Instant Messaging (IM) service network.

When source “Server” requires the network address of the target “Server”, the source “Server” will request address from the “Router”, the “Router” will seek address in the router service network based on the identification information of Target “Server” and routing strategy, and respond to the source “Server” when the target “Server” address is found.

FIG. 2 is the System deployment diagram of the invention—A new Instant Messaging (IM) system, it shows a typical system application and deployment scenario. The details are as follows:

(1) Enterprise A has deployed “Server” on their private Instant Messaging (IM) servers S1, S2, and S3 in their intranet; intranet users C1, C2 to C6 has used “Client” to create and login their account respectively in the three servers mentioned above, to access Instant Messaging (IM) and various enterprise application services.
(2) Enterprise B has deployed “Server” on their private Instant Messaging (IM) servers S4, and S5 in their intranet; intranet users C7, C8 to C13 has used “Client” to create and login their account respectively in the three servers mentioned above, to access Instant Messaging (IM) and various enterprise application services.
(3) Instant Messaging (IM) service provider has deployed “Server” on their Instant Messaging (IM) server targeted for public users S6, S7, S8 and S9; Public users C14, C15 to C21 has used “Client” to create and login their account respectively in the four servers mentioned above, to access Instant Messaging (IM) and various enterprise application services.
(4) Cloud service provider deploys “Server” to its Instant Messaging (IM) server S10, S11, S12 and S13, for being ready to provide its client the service to establish dedicated Instant Messaging (IM) server.
(5) Utilizing “Router”, equipment vendor establishes Router R1, R2, R4, and R5, and builds core backbone routing service network, provides addressing service for the servers of various enterprise and organizations.

The usage of the Instant Messaging (IM) system can be illustrated in the following scenarios:

1. Instant Messaging (IM) that does not Require Network Address Routing

This applies to internal Instant Messaging (IM) and relevant enterprise application within the enterprise or organization, it establishes internal Instant Messaging (IM) server to complete the system without the requiring core backbone routing service network: for example, the Instant Messaging (IM) among the C1, C2 to C6 users in Enterprise A is only required to access their private Instant Messaging (IM) servers S1, S2 and S3; the Instant Messaging (IM) among the C7, C8 to C13 users in Enterprise B is only required to access private Instant Messaging (IM) servers S4, and S5; the Instant Messaging (IM) among the Public user C14, C15 to C21 is only required to access public Instant Messaging (IM) server S1, S2 and S3.

2. Instant Messaging (IM) that Requires Network Address Routing

Instant Messaging (IM) across various enterprises or organizations, and that between public service users and enterprise intranet users will require the network address routing from the core backbone routing service network, to interconnect their Instant Messaging (IM) servers, in order for all the users to connect Instant Messaging (IM).

For example, When Users C1 and C2 from Enterprise A, Users C8 and C9 from Enterprise B, and Public users C20 and C21 connect a group messaging, their Instant Messaging (IM) servers S1, S5 and S9 will require network address routing from their associated routers R1, R2 and R4 in order to connect, then the users can connect Instant Messaging (IM).

The network address routing processes are as follows:

a) Assuming User C1 initiate group messaging, then the Server S1 that C1 logged-in will be responsible in seeking the server network address of other users.
b) C1 will send network address routing request to R1, based on the routing request of the target server identification data, routing will be conducted in the core backbone network routing service according routing policy.
c) When Router R2 and R4 received the address request, it will respond the network address of Servers S5 and S9 to Router R1, after that Router R1 will respond the network address of Servers S5 and S9 to Server S1.
d) Finally, Server S1 will establish network connection with Servers S5 and S9 base on the network address received from feedback, group messaging starts.
3. Instant Messaging (IM) that Requires Dedicated Server

Cross enterprise or organizations Instant Messaging (IM) that has higher demand in privacy, and Instant Messaging (IM) between public users and enterprise or organizations' users, can lease an Instant Messaging (IM) server from cloud service provider, creating a dedicated Instant Messaging (IM) server for a specific project, task or user group; for example: To manage a collaborative project, Users C5 and C6 from Enterprise A, Users C10, C11 and C12 from Enterprise B, Public users C17 and C18, can lease Instant Messaging (IM) server S11 from cloud service provider, and use the Assigning Server S11 as the dedicated server for the project, create and add new accounts. The additional advantage for this method is that, all instant messages can be audited, and be able to completely track the status of the collaborative project.

1-7. (canceled)

8. A Instant Messaging (IM) system, comprising “Client”, “Server” and “Router”, which is characterized as:
the “Client” acts as the interface of Instant Messaging (IM) system, each “Client” connects by Instant Messaging (IM) with each other through the “Server”;
the “Server” provides various applications to the “Client”;
the “Router” is used for managing the connection of the “Server”, and providing an addressing service for the network connection amongst the “Server”.

9. The Instant Messaging (IM) system of claim 8, which is characterized as: the “Client” is installed at the user's mobile phone, tablet, or computer, the “Client” is the interface for Instant Messaging (IM), receiving broadcast message, biometric attendance, creating temporary task group, group administration, task assignment, email and enterprise applications.

10. The Instant Messaging (IM) system of claim 8, which is characterized as: the “Server” is installed onto the Instant Messaging (IM) server, the “Server” provides biometric attendance, creates temporary task group, group administration, task assignment, email, enterprise applications, message broadcast, and Instant Messaging (IM) service; the “Server” are directly connected based on the network address, without requiring network address routing from the “Router” when the network address of the target “Server” is known.

11. The Instant Messaging (IM) system of claim 8, which is characterized as: the “Server” can be a private Instant Messaging (IM) server within an enterprise or organization, or dedicated Instant Messaging (IM) server leased by users from various enterprise or organizations, or Instant Messaging (IM) server aimed at public users deployed by service providers, after acquiring authorization from the owner of the server, these servers can interconnect and communicate to form a scalable Instant Messaging (IM) service network.

12. The Instant Messaging (IM) system of claim 8, which is characterized as: the “Router” will provide addressing service to facilitate the interconnectivity and communication among the “Server”, every “Router” will provide addressing service to one or more “Server”, and every “Server” will only accept addressing service from a specific “Router”.

13. The Instant Messaging (IM) system of claim 8, which is characterized as: the “Router” are uniformly deployed by the equipment vendor, for creating core backbone Instant Messaging (IM) routing service network; large enterprise or organizations, and public Instant Messaging (IM) service provider can collaborate to build larger scale of Instant Messaging (IM) network through deployment of the “Router”, and be able to join the core backbone Instant Messaging (IM) service network.

14. The Instant Messaging (IM) system of claim 8, which is characterized as: when source “Server” requires the network address of target “Server”, the source “Server” will request address from the “Router”, the “Router” will seek address in the router service network based on the identification information of target “Server” and the preset routing strategy, then respond to the source “Server” when the target “Server” address was found.
